(19) United States
(12) Patent Application Publication
(10) Pub. No.: US 2014/0031118 A1
(43) Pub. Date: Jan. 30, 2014

(54) INTERACTIVE VIRTUAL FARMING VIDEO GAME

(71) Applicant: Michael A. Liberty, Windermere, FL (US)

(72) Inventor: Michael A. Liberty, Windermere, FL (US)

(21) Appl. No.: 13/954,847

(22) Filed: Jul. 30, 2013

Related U.S. Application Data
(60) Provisional application No. 61/677,313, filed on Jul. 30, 2012.

(51) Int. Cl. A63F 13/00

(52) U.S. Cl. CPC A63F 13/00
USPC 463/31

(57) ABSTRACT

A virtual, interactive farm-based video game can provide one or more interactive scenarios that are playable by the user. Upon receiving a selection from the user, the game can depict instructions relating the one or more interactive scenarios to an equivalent real-world farm-based scenario. The game can then provide the interactive scenario within the farm-based video game that requires the user to perform virtual actions that correspond to the equivalent real-world farm-based scenario.

### CROSS-REFERENCE TO RELATED APPLICATIONS

This application claims priority to and the benefit of U.S. Provisional Application Ser. No. 61/677,313, entitled “Interactive Virtual Farming Video Game”, filed on Jul. 30, 2012, which application is incorporated by reference herein in its entirety.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork and more. Software applications are often designed to perform specific tasks, such as word processor applications for drafting documents, or email programs for sending, receiving and organizing email.

In some cases, software applications are designed for entertainment. For instance, video games have become a huge industry for entertaining people. Casual video games are designed for the more casual gamer, while more intense video games are designed for the hard-core gamer. Video games may be console-based, personal computer (PC) based, social media-based, internet-based or may be provided on some other platform. Some video games have been designed to provide not only entertainment, but also education. Such video games, however, often lack the appeal of the purely entertainment-based video games.

### BRIEF SUMMARY

Embodiments described herein are directed to a system and method for implementing a virtual, interactive farm-based video game. The system and method can provide a user with a variety of different virtual farm-based activities. Each of the activities can include educational components that instruct a user on how to perform the activities in a real-world farming scenario. The virtual farm-based activities can allow a user to perform the activities in a way that corresponds with the real-world farming scenario.

Additionally, in some embodiments, the invention can include a method for receiving input from a user indicating that the virtual, interactive farm-based video game is to be initiated. The present invention can then initiate the virtual, interactive farm-based video game on the computer system. The farm-based video game can provide one or more interactive scenarios that are playable by the user. Upon receiving a selection from the user, the game can depict instructions relating the one or more interactive scenarios to an equivalent real-world farm-based scenario. The game can then provide the interactive scenario within the farm-based video game that requires the user to perform virtual actions that correspond to the equivalent real-world farm-based scenario.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof, which are illustrated in the appended drawings. It should be noted that the figures are not drawn to scale, and that elements of similar structure or function are generally represented by like reference numerals for illustrative purposes throughout the figures. Understanding that these drawings depict only typical embodiments of the invention and are not therefore to be considered to be limiting of its scope, the invention will be described and explained with additional specificity and detail through the use of the accompanying drawings in which:

FIG. 1 is a schematic illustration of a system for initializing an embodiment of a virtual, interactive farm-based video game;

FIG. 2 is a schematic illustration of a system for playing an embodiment of a virtual, interactive farm-based video game;

FIG. 3 is an illustration of a flowchart of a series of acts in a method in accordance with an implementation of the present invention for initializing and/or playing a virtual, interactive farm-based video game; and

FIG. 4 is an illustration of another flowchart of a series of acts in a method in accordance with an implementation of the present invention for initializing and/or playing a virtual, interactive farm-based video game.

### DETAILED DESCRIPTION

Embodiments described herein include providing a virtual, interactive farm-based video game to one or more users. The farming video game may provide many different interactive scenarios for users to learn about and experience farming, in a virtual manner. The user can create their own avatar and use that avatar to perform farm-based tasks such as milking a cow, planting and harvesting crops, making homemade jelly and selling it at a virtual market, and other similar tasks. Each interactive scenario may include instructional videos to help educate the user and teach them proper methods for performing the various tasks. Although a few specific interactive scenarios are described herein, it will be appreciated that many different scenarios may be programmed and implemented in the virtual farming video game.

The following discussion now refers to a number of methods and method steps or acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments described herein can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmission media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that various embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. Embodiments described herein may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

Additionally or alternatively, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and other types of programmable hardware.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

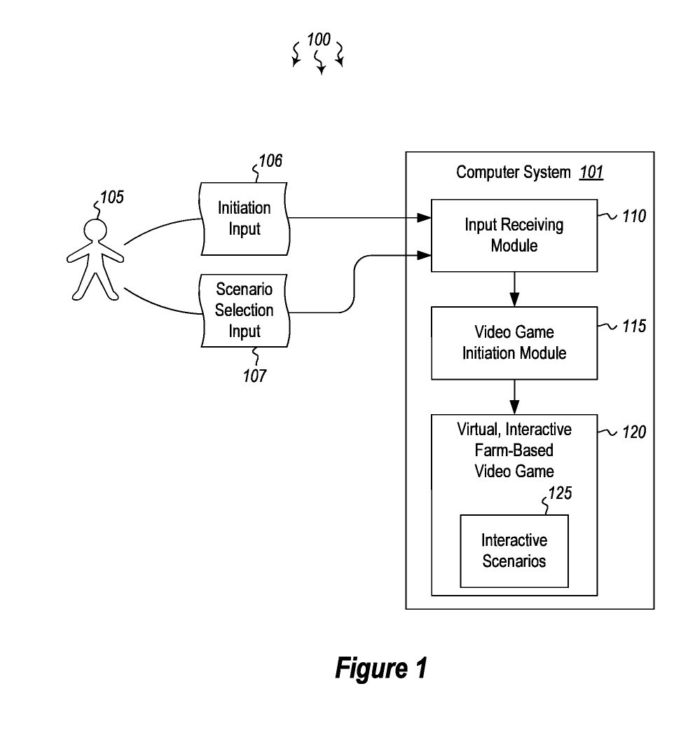

FIG. 1 illustrates a computer architecture 100 in which at least one embodiment may be employed. Computer architecture 100 includes computer system 101. Computer system 101 may be any type of local or distributed computer system, including a cloud computing system. The computer system includes various modules for performing a variety of different functions. For instance, the input receiving module 110 is configured to receive inputs from one or more users (e.g. user 105). User 105 may be any type of computer or video game user, and may provide input to the computer system and/or to the video game 120 in a variety of manners. For example, the user may interact using a mouse, keyboard, touch inputs (on a touchscreen), gestures (via a touchscreen or camera), voice (via a microphone) or other forms of input. Moreover, any combination of input types may be used to interact with the computer system 101 and/or the virtual, interactive farm-based video game 120.

The input 106 may indicate that the virtual, interactive farm-based video game 120 (or “farm game” or “farm video game” or “video game” herein) is to be initiated on the computer system. In response, the video game initiation module 115 may initiate the video game on the computer system 101. The video game may run on a single computer system, or on a plurality of computer systems (such as on the cloud). The video game may thus be presented to the user locally or over the internet or other network such as a cellular telephone network. The virtual, interactive farm-based video game 120 may be presented on a variety of different digital devices including PCs, laptops, tablets, smart phones, cellular phones, portable game devices and other digital devices. The video game may be presented as a stand-alone application or within a browser or as part of some other application.

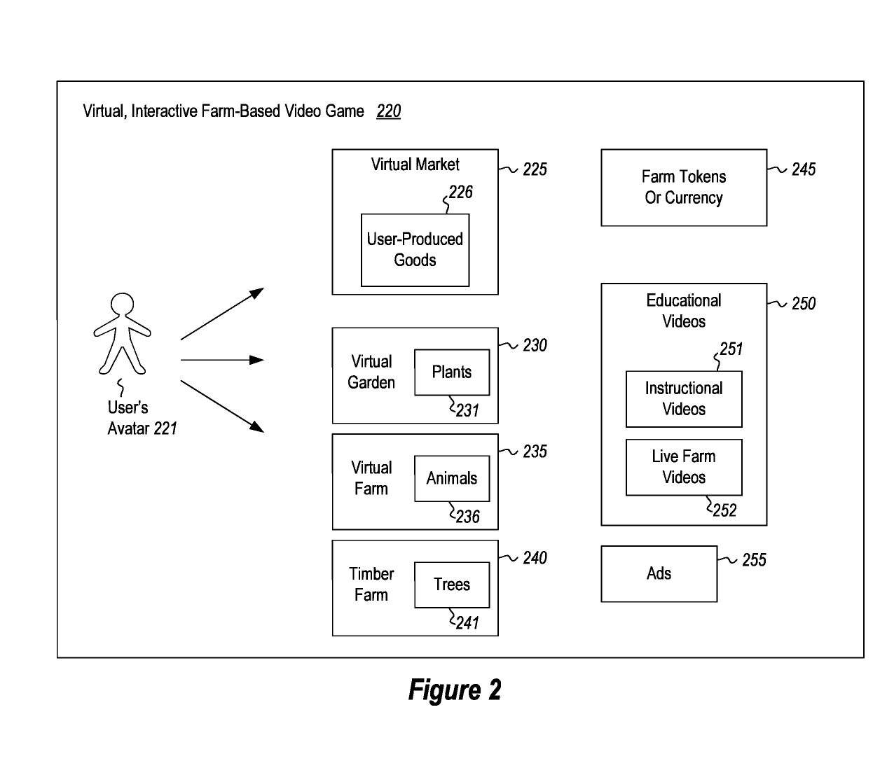

The virtual, interactive farm-based video game 120 may provide multiple different farm-based interactive scenarios 125. Each scenario may be selected by the user (e.g. via input 107), or the scenarios may be presented automatically in response to some other setting or selection. As shown in FIG. 2, the video game 220 may include multiple different elements, depending on what the video game user wants to do. In some cases, all possible options are available to the user, and in other cases, a subset of the options may be available based on what the user has paid for or qualified for (e.g. through leveling up, etc.).

Each user in the virtual, interactive farm-based video game 120 has one or more avatars 221. The avatar may be customized by the user in the manner they choose, selecting height, weight, hair color, eye color, clothing and many other customizable characteristics. The user may also apply a picture of his or her own face to the avatar so that the avatar looks like the user in the video game.

The virtual, interactive farm-based video game 120 includes a currency system that may be referred to as “farm tokens” or “farm dollars” 245 herein. These farm dollars may be used to purchase items within the video game, such as, for example, at the virtual market 225. The virtual market may include a variety of different goods, including user-produced goods 226. Accordingly, a user may raise crops, animals, or other homemade goods and sell them at the virtual market. In some cases, the selling prices of the goods may mirror that of current market prices. Accordingly, at least in some cases, a user may sell milk from their cows at the virtual market 225 for the same price it would sell for in the real milk market. The user may accumulate farm currency from items sold at the virtual market, and may used the accumulated funds to make other purchases (such as new farm equipment, a new cow, chickens, seeds, animal food or any number of things that may be sold in the virtual market).

In some cases, farm dollars or tokens may be received when the user 105 completes a farm-related task. For instance, if the user plants strawberries, or grooms a horse or feeds the chickens, the video game may issue a specified amount of currency 245. This amount may be dependent on a variety of different factors and settings. For instance, the user may receive more money for completing a specified task when they have more experience doing that task. Similarly, a user may be receive more or less money based upon how well the user completes a specified task. These tasks may be customized for each scenario, for different age groups, for different skill sets or based on other considerations.

The virtual, interactive farm-based video game 120 may include multiple different interactive scenarios where users can learn about and actively participate in performing farm-related tasks. For instance, the user 105 may plant a virtual garden 230 with an assortment of different crops 231. The user may plant the seeds, water the seeds, remove weeds, remove pests, and perform any other tasks related to growing the specific vegetable, fruit or grain they planted. In some embodiments, the planted crops may grow in real-time. That is, if a plant normally takes 16 weeks to sprout and grow, the virtual plant 231 in the virtual garden 230 will take 16 weeks to sprout and grow. The user can view and track the progress of their plants in this interactive scenario. Accordingly, the user may see images ranging from seedlings to growing plants to blooming to produce-bearing stage.

As the plants are growing, the user may notice that some of the plants are growing poorly. If such is the case, the user can take various actions to revive the plant such as adding fertilizer or nitrates, or giving the plant extra water. The farm-based video game 120 may provide educational videos, slides, illustrations or other information to educate the user on why the plants are growing poorly, and what may be done to help the plant grow better. The education information can be based upon real-world farm knowledge and insight, such that a user is learning and applying real farm techniques to his or her virtual farm. Such educational information may be given to users at various stages in the game. In some cases, the users may be tested or quizzed on the content of the educational information to ensure that the user is learning throughout the process.

Another interactive scenario may include a virtual farm 235 with virtual animals 236. Similar to the virtual garden, a user may purchase chicks, calves, piglets, foals or other baby animals and raise them to maturity. Tasks may include feeding the animals, cleaning the animals (including their waste), performing health checks and nursing the animals back to health when sick. In some cases, the animals may grow and develop in real-time, and in other cases, the timeframe may be sped up by a specified factor.

As with the plants scenario above, educational videos 250 may be provided within the game to instruct the user how to perform one or more of the tasks. For example, educational information may be provided that teaches a user about identifying and treating various maladies, infections, and/or injuries that can afflict different farm animals, or teaching a user about appropriate diets for individual farm animals. Such instructional videos 251 may show actual farmers performing those tasks in a farm setting. In some cases, the videos may be live videos 252 streamed from a farm. In other cases, the videos may be prerecorded. In such cases, the videos may be part of the game itself, or may be retrieved from a third party video host on the internet such as YouTube(r). In still other cases, the educational videos 250 may show an in-game avatar performing the task to demonstrate to the user 105 how the task is to be performed. Educational information in the form of text, audio, video or a combination thereof may be provided in addition to the video to help reinforce certain concepts.

In some embodiments, an instructional avatar may be provided as part of an educational program. The educational program may be part of a school class (e.g. dairy science) and may include class instruction and demonstrations. The educational program may be part of an accredited program, so that upon completion, the user can receive school credit or some type of certificate for passing the program. In such cases, the instructional videos may depict a teacher or professor describing or actually showing how farm processes work including everything from the daily chores to the business aspects of running a farm. The educational program may include quizzes, tests, homework assignments and all other elements commonly associated with an educational class. Such classes may be tailored to different ages of students including children, adolescents and adults.

As part of the educational programs, a user can be required to perform business related “book keeping” functions within the virtual game. For example, a user may be required to pay workers that work on the virtual farm, pay maintenance costs, pay for feed, etc. In at least one embodiment, the costs that a user must account for are the real-world market costs of each respective item or service that a real-world farm must account for.

Another interactive scenario may include a timber farm 240. In such a scenario, a user 105 may learn to control various aspects of timber farming such as learning where to find the best trees, learning trucking logistics, learning how to replant trees 241 and other timber management items. Another scenario may involve horses including allowing the user to purchase, raise, ride, train and maintain horses. Still another interactive scenario may involve chickens including buying, feeding and selling chickens including gathering and selling eggs. Each of these items may be bought and sold at the virtual market. The user may also build and design habitats including henhouses, horse stables, pigpens and other environments. Other interactive scenarios may include raising other animals such as pigs, sheep or goats. Virtually any type of interactive farming scenario may be included or added onto the farming video game 220.

Thus, in some cases, a user may be a farmer in charge of his or her own farm. The user may buys cows at auction, drive the cows back to his or her farm, buy tractors, raise crops, gather milk and sell it at market, control irrigation water, train and ride horses, grow strawberries or perform any number of other things within the virtual, interactive world provided in the video game 220. In some cases, customized advertisements 255 are displayed on the user's virtual farm. The user may receive farm dollars or tokens 245 from the ads.

In some embodiments, the user 105 may produce and brand their own goods 226 for sale at the virtual market 225. The user can customize their goods with their own brand name (e.g. John Doe's homemade jelly) and sell them at the virtual market. The money received from the sales may be stored in the user's farm currency account. In some cases, sponsored goods may be sold in the virtual market such as brand name overalls, brand name tractors, brand name boots, brand name foods or other brand name farm-related goods. The user 105 may be able to purchase these brand name goods at the virtual market 225 and use them on their virtual farm or on their avatar (in the case of clothes such as overalls or boots).

In at least one embodiment, the virtual market can provide a place where a number of different users can meet within the game to sell and trade items. Additionally, in at least one embodiment, the quality and value of a user's items can increase or decrease based upon the skill with which the user grew and/or cared for the item (e.g., livestock, crops, timber, etc.). For instance, the user's items can be of greater or lesser quality based upon how closely the user complied with educational requirements. For example, a user that properly cares for cattle, as the user is taught within the game, may produce beef of a higher quality and value than other users who neglect to properly feed and/or medically attend to their cattle.

Accordingly, a user who learns from the educational components of the video game and practices proper farming techniques may be able to demand more money for his or her product at the virtual market than a user with little skill. As such, a user's ability to brand his or her own products may aid the user in establishing the brand as a high quality brand within the virtual market and thus allow the user to more easily demand a premium for the user's product.

In at least one embodiment, the virtual store can also provide actual real-world fulfillment of at least some orders. For instance, a user may be able to order from the virtual store an actual real-world jar of the user's self-branded jam. The user may purchase this real-world jam using farm tokens or currency or real-world money. In particular, this self-branded jam may virtually represent jam that the user virtually made from fruit that the user virtually cultivated.

In at least one implementation, this can be accomplished by providing the user's virtual store order to a real-world fulfillment company. The fulfillment company can print a branding label for a real-world jar of jam that corresponds with the user's virtual brand (or whatever virtual brand of jam that the user purchased on the virtual store). The fulfillment store can then ship the purchased item(s) to the address that the user specifies. One will understand that similar arrangements could be created for the real-world fulfillment of a variety of different virtual products (e.g., milk, steak, fresh apples, eggs, etc.).

In still further embodiments, the user may be able to add farm tokens or farm dollars 245 to his or her in-game currency account using real-world currency. Accordingly, a user may use $10 or real-world money to buy 10 farm dollars or tokens, or another equivalent mount. This may be used as a reward in some cases, where a parent rewards their child for performing tasks in the game (e.g. caring for a baby calf). If the child successfully feeds and cares for the calf, the parent may apply real-world dollars to the child's in-game currency account. The child may then use the farm dollars to purchase new items for their farm and/or upgrade their farm. Accordingly, a child may learn to become responsible for the animals or crops that are in their care in the video game. Moreover, the child may learn through educational videos how various farm-related tasks are to be performed and how life on a farm actually is.

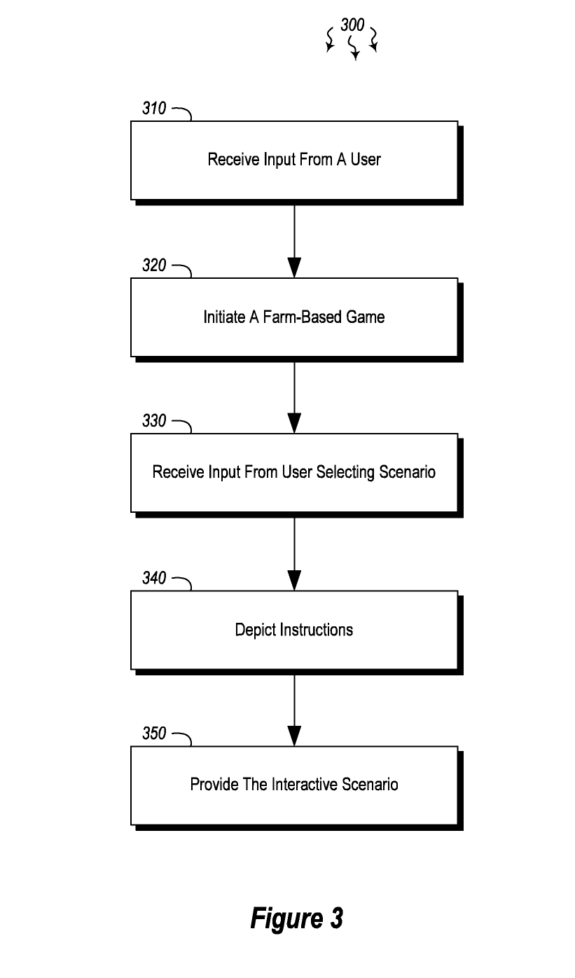

In one embodiment, as described in FIG. 3, a method 300 is provided for establishing a virtual, interactive farm-based video game. Method 300 includes an act of receiving input from a user indicating that the virtual, interactive farm-based video game is to be initiated (act 310). In response to the input from the user, a computer system can initiate the virtual, interactive farm-based video game (act 320). The virtual, interactive farm-based video game can provide one or more interactive scenarios that a user can play. A user can select at least one of the provided interactive scenarios (act 330). After receiving a selected scenario from the user, the video game can depict to the user instructions relating the one or more interactive scenarios to an equivalent real-world farm-based scenario, such that the user is provided instruction on how to correctly perform the scenario in the equivalent real-world farm-based scenario (act 340). The virtual, interactive farm-based video game can then provide the interactive scenario to the user within the virtual, interactive farm-based video game (act 350). The interactive scenario can require the user to perform virtual actions that correspond to the equivalent real-world farm-based scenario.

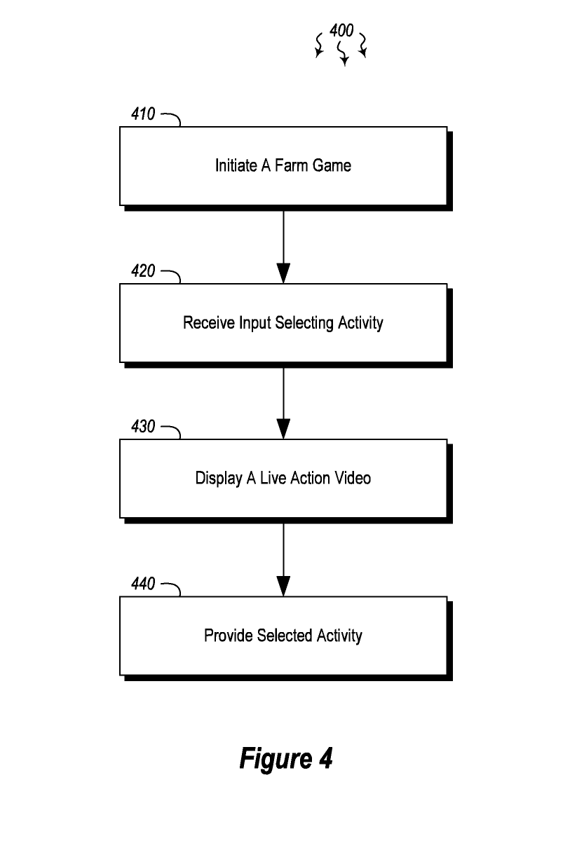

In another embodiment, as described in FIG. 4, a method 400 is provided for establishing a virtual, interactive farm-based game. Method 400 includes an act of initiating the virtual, interactive farm-based video game on a computer system (act 410). The video game can provide one or more virtual farm-based activities that are playable by a user. A user can select at least one of the virtual farm-based activities (act 420). After receiving a selection from the user, the video game can display a live action video of an individual performing the real-world farm-based activity that is equivalent to the activity that the user selected (act 430). The video game can then provide the activity within the virtual, interactive farm-based video game (act 440). The virtual farm-based activity can require the user to perform virtual actions that correspond to the equivalent real-world farm-based activity.

Accordingly, methods, systems and computer program products are provided which initiate and provide a virtual, interactive farm-based video game. The video game works on a variety of different mediums and devices. The video game provides many different interactive scenarios for users to learn about raising crops, caring for farm animals and learning about the economics of farming.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A computer system, comprising:
at least one processor;
system memory;
one or more computer-readable storage media having stored thereon computer-executable instructions that, when executed by the one or more processors, causes the computing system to perform a method for providing a virtual, interactive farm-based video game, the method comprising the following:
receiving input from a user indicating that the virtual, interactive farm-based video game is to be initiated;
initiating the virtual, interactive farm-based video game on the computer system, the virtual, interactive farm-based video game providing one or more interactive scenarios that are playable by the user;
receiving input from the user selecting at least one of the interactive scenarios;
depicting to the user instructions relating the one or more interactive scenarios to an equivalent real-world farm-based scenario such that the user is provided instruction on how to correctly perform the scenario in the equivalent real-world farm-based scenario; and
providing the interactive scenario within the virtual, interactive farm-based video game, wherein the interactive scenario requires the user to perform virtual actions that correspond to the equivalent real-world farm-based scenario.

2. The computer system of claim 1, wherein the user creates or selects an existing avatar.

3. The computer system of claim 2, wherein the user customizes the avatar to incorporate a picture of the user's face into the user's avatar.

4. The computer system of claim 1, wherein the user produces and brands their own goods for sale at the virtual market within the virtual, interactive farm-based video game.

5. The computer system of claim 1, wherein the user accumulates farm currency including at least one of farm dollars and farm tokens.

6. The computer system of claim 5, wherein farm currency is received when the user sells one or more items at a virtual market within the virtual, interactive farm-based video game.

7. The computer system of claim 6, wherein crops, animals or other goods are sold at the virtual market in the virtual, interactive farm-based video game at their real-market value.

8. The computer system of claim 1, wherein an avatar instructor is provided in the virtual, interactive farm-based video game to instruct the user how to perform one or more specified tasks in the equivalent real-world farm-based scenario.

9. The computer system of claim 8, wherein the avatar instructor is provided as part of an accredited educational program such that the user can receive credit for passing the program.

10. The computer system of claim 1, wherein the virtual, interactive farm-based video game is provided on one or more of the following: the internet, a social-media platform, and a video game console.

11. The computer system of claim 1, wherein customized ads are displayed on the user's virtual farm, and wherein the user receives farm tokens from the ads.

12. The computer system of claim 1, wherein the virtual, interactive farm-based video game displays one or more videos from a real-world farm.

13. The computer system of claim 1, wherein one or more of the goods displayed in the virtual, interactive farm-based video game includes a sponsor's logo or advertisement.

14. A method for providing a virtual, interactive farm-based video game, the method comprising the following:
initiating the virtual, interactive farm-based video game on the computer system, the virtual, interactive farm-based video game providing one or more virtual farm-based activities that are playable by a user;
receiving input from the user selecting at least one of the virtual farm-based activities;
displaying a live action video of an individual performing the real-world farm-based activity that is equivalent to the selected at least one virtual farm-based activity; and
providing the selected at least one virtual farm-based activity within the virtual, interactive farm-based video game, wherein the virtual farm-based activity requires the user to perform virtual actions that correspond to the equivalent real-world farm-based activity.

15. The method of claim 14, further comprising determining the outcome of the virtual farm-based activity based upon the degree to which the user follows an established technique for performing the virtual farm-based activity, wherein the technique for performing the virtual farm-based activity corresponds with an equivalent real-world technique.

16. The method of claim 14, further comprising:
presenting the user with a production problem relating to the virtual farm-based activity, wherein the production problem corresponds with a real-world farm production problem;
receiving input from the use directed towards mitigating the production problem;
determining that the received input properly addresses the production problem; and
removing the production problem from the virtual farm-based activity.

17. The method of claim 16, wherein the production problem comprises a virtual malady requiring treatment.

18. The method of claim 16, wherein the production problem comprises a virtual maintenance task that must be performed.

19. The method of claim 14, wherein the virtual farm-based activity comprises applying a proper mixture and amount of virtual fertilizers to a specific type of virtual crop, wherein the proper mixture and amount of the virtual fertilizers corresponds to a proper mixture and amount of fertilizers that would be applied to a specific corresponding real-world crop.

20. The method of claim 14, wherein the virtual farm-based activity comprises designing, purchasing the necessary supplies, and building an animal habitat within the virtual, interactive farm-based video game.
